(19) United States
(12) Patent Application Publication
(10) Pub. No.: US 2008/0022386 A1
(43) Pub. Date: Jan. 24, 2008

(54) Security mechanism for server protection

(76) Inventor: Oleksiy Yu. Shevchenko, Ashburn, VA (US)

Correspondence Address: MCDERMOTT WILL & EMERY LLP, 600 13TH STREET, N.W., WASHINGTON, DC, 20005-3096, US

(21) Appl. No.: 11/448,865

(22) Filed: Jun. 8, 2006

(51) Int. Cl. G06F 15/16

(52) U.S. Cl. 726/12

(57) ABSTRACT

Novel system and methodology for server protection by preventing the protected server from receiving packets supplied by a user and/or preventing the server from transmitting packets to the user. A server protection device has a user communication mechanism for controlling communication with the user and a server communication mechanism for controlling communication with the server. A user information extracting mechanism extracts predetermined information and removes external address information from user packets sent by the user for delivery to the server. A user information control mechanism checks the extracted predetermined information to allow acceptable information to pass to the server communication mechanism and to prevent unacceptable information from passing to the server communication mechanism. Internal packets produced by the protection device and containing the acceptable information are transferred by the server communication mechanism to the server.

### TECHNICAL FIELD

This disclosure relates to computer security, and more particularly, to security system and methodology for protecting a server, such as a database server or a web server, in a client-server architecture.

### BACKGROUND ART

In a client-server computer architecture, resources are split between server tasks and client tasks. A client sends requests to a server, according to a prescribed protocol, asking for information or action, and the server responds. The client may be a computer system or process that requests a service of another computer system or process and accepts its responses. The server may be a computer system or process which provides some service for the client connected via a link or network to the server. For example, a client's workstation may use a browser to send HTTP requests to a web server run at a remote web site. The web server may respond to the client by sending web pages.

Another example of a server in a client-server architecture is a database server, which may be a stand-alone computer system for holding and managing a database. A client may access the database server over the Internet or any other communication link. In a database server, database management functions, such as locating the actual record being requested, is performed in the server computer that may incorporate various hardware resources including one or more high-speed processors.

A database server may run database management system (DBMS) including a suite of programs for managing large structured sets of persistent data, offering ad hoc query facilities to multiple users. The DBMS may control the organization, storage and retrieval of data in a database. It also controls the security and integrity of the database. The DBMS accepts requests for data from the application program and instructs the operating system to transfer the appropriate data.

Various data formats may be used for supporting communications between database servers and clients. For example, an SQL database management system, such as Microsoft SQL Server or Sybase SQL Server, responds to queries from clients formatted in the SQL language used for creating, updating and querying relational database management systems.

The DBMS may support data security schemes to prevent unauthorized users from viewing or updating the database. Using passwords, the DBMS can allow users to access the entire database or specific subsets of the database. For example, an employee database can contain all the data about an individual employee, but one group of users may be authorized to view only payroll data, while others are allowed access to only work history and medical data.

The DBMS can maintain the integrity of the database by not allowing more than one user to update the same record at the same time. The DBMS can keep duplicate records out of the database, for example, to prevent more than one customer with the same customer number to access the database.

Query languages and report writers allow users to interactively interrogate the database and analyze its data. If the DBMS provides a way to interactively enter and update the database, as well as interrogate it, this capability allows for managing personal databases. However, it may not leave an audit trail of actions or provide the kinds of controls necessary in a multi-user organization.

In the past several years, threats in the cyberspace have risen dramatically. With the ever-improving tools used by hackers to access databases, new challenges face database servers. Database environments are now opened to perpetrators using malicious software or malware to steal or damage data, or misuse databases. The software industry responded with multiple products and technologies to address the challenges.

One way to compromise the security of a server is to cause the server to execute software such as Trojan horse that performs harmful actions on the server. For example, recently discovered Ransom-A Trojan horse displays messages threatening to delete files in the attacked database one-by-one every 30 minutes, until a ransom demand is fulfilled. The Trojan asks for payment and promises delivery of a special disarming code after the ransom is paid.

Another Trojan, dubbed Cryzip, encrypts victims' files and demands a payment to have them decrypted and unlocked. The Cryzip Trojan searches for files, such as source code or database files, on infected systems. It then uses a commercial zip library to store the encrypted files. The Trojan overwrites the victims' text and then deletes it, leaving only encrypted material that contains the original file name and encrypted data.

Attack or exploit codes are developed by hackers to take advantage of flaws in database software to steal or destroy data. For instance, the attack code may give the attacker higher privileges on the attacked database system.

There are various types of security measures that may be used to prevent a computer system from executing harmful software. System administrators may limit the software that a computer system can approach to only software from trusted developers or trusted sources. For example, the sandbox method places restrictions on a code from an unknown source. A trusted code is allowed to have full access to computer system's resources, while the code from an unknown source has only limited access. However, the trusted developer approach does not work when the network includes remote sources that are outside the control of the system administrator. Hence, all remote code is restricted to the same limited source of resources. In addition, software from an unknown source still has access to a local computer system or network and is able to perform harmful actions.

Another approach is to check all software executed by the computer device with a virus checker to detect computer viruses and worms. However, virus checkers search only for specific known types of threats and are not able to detect many methods of using software to tamper with computer's resources.

Further, firewalls may be utilized. A firewall is a program or hardware device that filters the information coming through the Internet connection into a private network or computer system. If an incoming packet of information is flagged by the filters, it is not allowed through. Firewalls use one or more of the following three methods to control traffic flowing in and out of the network.

A firewall may perform packet filtering to analyze incoming data against a set of filters. The firewall searches through each packet of information for an exact match of the text listed in the filter. Packets that make it through the filters are sent to the requesting system and all others are discarded.

Also, a firewall may carry out proxy service to run a server-based application acting on behalf of the client application. Accessing the Internet directly, the client application first submits a request to the proxy server which inspects the request for unsafe or unwanted traffic. Only after this inspection, the proxy server considers forwarding the request to a required destination.

Further, a firewall may perform stateful inspection, where it doesn't examine the contents of each packet but instead compares certain key parts of the packet to a database of trusted information. Information traveling from inside the firewall to the outside is monitored for specific defining characteristics, then incoming information is compared to these characteristics. The firewall looks not only at the IP packets but also inspect the data packet transport protocol header in an attempt to better understand the exact nature of the data exchange. If the comparison yields a reasonable match, the information is allowed through. Otherwise it is discarded.

However, the firewall technologies may miss vital information to correctly interpret the data packets because the underlying protocols are designed for effective data transfer and not for data monitoring and interception. For instance, monitoring based on an individual client application is not supported despite the fact that two identical data packets can have completely different meaning based on the underlying context. As a result, computer viruses or Trojan Horse applications can camouflage data transmission as legitimate traffic.

Further, a firewall is typically placed at the entry point of the protected network to regulate access to that network. However, it cannot protect against unauthorized access within the network by a network's user.

Also, advanced firewall and proxy strategies are based on a centralized filter mechanism, where most of the filtering operations are performed at the server. During operation of a typical centralized firewall, a single server might have to do the filtering work for hundreds of PC or workstations. This represents a major bottleneck to overall system performance. In the case of the statewide inspection, performance problems are aggravated because the firewall software needs to duplicate much of the protocol implementation of the client application as well as the transport protocol in order to understand the data flow. Providing a client-based filter does not adequately overcome the disadvantages of centralized filtering.

Accordingly, current methods have had only limited success in addressing cyberspace security problems. None of known computer protection methodologies is able to completely protect database or web servers. For example, no reliable protection is available against spyware or unknown threats.

Therefore, it would be desirable to create a new security mechanism that would provide complete server protection by physically isolating a server from interaction with a user.

### SUMMARY OF THE DISCLOSURE

The present disclosure offers novel circuitry and methodology for server protection by physically isolating a server to prevent the protected server from receiving packets supplied by a user and/or prevent the server from transmitting packets to the user. In accordance with one aspect of the present disclosure, a server protection device has a user communication mechanism for controlling communication with the user and a server communication mechanism for controlling communication with the server. In responsive to the user communication mechanism, a user information extracting mechanism extracts predetermined information and removes external address information from user packets sent by the user for delivery to the server. A user information control mechanism checks the extracted predetermined information to allow acceptable information to pass to the server communication mechanism and to prevent unacceptable information from passing to the server communication mechanism. Internal packets produced by the protection device and containing the acceptable information are transferred by the server communication mechanism to the server. A user packet assembling mechanism may be provided for producing the internal packets having internal address information supplied instead of the external address information.

For example, the user information control mechanism may provide user authorization to access the server. Also, the user information control mechanism may determine user rights to access particular information from the server. In addition, the user information control mechanism may check the structure of information in the packets received from the user.

In accordance with another aspect of the disclosure, the server communication mechanism may receive server packets sent by the server for delivery to the user. A server information extracting mechanism may extract prescribed information from the server packets. A server information control mechanism may check the prescribed information to allow acceptable information from the server to pass to the user communication mechanism and to prevent unacceptable information from the server from passing to the user communication mechanism.

The server information control mechanism may modify information received from the server in accordance with a prescribed rule. For example, the server information control mechanism may check whether an address of the user is allowed to receive information sent by the server. The server information control mechanism may modify the information sent by the server if the address of the user is not allowed to receive the information sent by the server

A server packet assembling mechanism may be provided for transferring to the user communication mechanism packets containing the acceptable information. The server packet assembling mechanism may produce packets containing the address information removed from the user packets received from the user.

The server communication mechanism may communicate with the server over a server bus. A nontransparent bridge may be arranged to support the communication with the server.

The server protection device may further comprise a session management mechanism for controlling a communication session between the user and the server. In particular, the session management mechanism may provide the server packet assembling mechanism with source and destination address information removed from the user packets received from the user.

For example, the protected server may hold a database. Alternatively, the protected server may be a web server.

The server protection device of the present disclosure may support communication of a server with a thin client as well as with a thick client. Also, the server protection device may support a database server that interacts with a user via a web server, which also may be protected by the server protection device of the present disclosure.

In accordance with a further aspect of the disclosure, a computer system includes a server, such as a database server or a web server, configured for interacting with a client, and a protection device configured for preventing the server from receiving packets from the client and transmitting packets to the client. The protection device comprises:
a client communication mechanism for receiving client's packets addressed to the server, and for transmitting to the client internal transmit packets produced by the protection device based on information transmitted from the server, and
a server communication mechanism for receiving server's packets addressed to the client, and for sending to the server internal receive packets produced by the protection device based on information received from the client.

The protection device may further comprise:
a client information extracting mechanism responsive to the user communication mechanism for extracting predetermined information and removing external address information from the client's packets, and
a client information control mechanism for checking the extracted predetermined information to allow acceptable information to pass to the server communication mechanism and to prevent unacceptable information from passing to the server communication mechanism.

Also, the protection device may comprise:
a server information extracting mechanism responsive to the server communication mechanism for extracting prescribed information from the server's packets, and
a server information control mechanism for checking the prescribed information to allow acceptable information from the server to pass to the client communication mechanism and to prevent unacceptable information from the server from passing to the client communication mechanism.

In accordance with a method of the present disclosure, the following steps are carried out to provide data communications between a user and a server:
receiving user's packets addressed to the server,
processing the user's packets to extract predetermined information,
producing internal receive packets based on the predetermined information, and
sending the internal receive packets to the server.

The method of the present disclosure may further comprise the steps of:
receiving server's packets addressed to the user,
processing the server's packets to extract prescribed information,
producing internal transmit packets based on the prescribed information, and
transmitting the internal transmit packets to the user.

Also, the method of the present disclosure may include the steps of:
checking the predetermined information extracted from the user's packets to remove unacceptable information so as to produce the internal receive packets without the unacceptable information, and
checking the prescribed information extracted from the server's packets to remove unacceptable information so as to produce the internal transmit packets without the unacceptable information.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIGS. 1A-1C illustrate various applications of server protection devices of the present disclosure;

FIG. 2 illustrates an exemplary platform for providing the server protection device of the present disclosure;

FIG. 3 illustrates server protection operations performed by the server protection device of the present disclosure.

### DETAILED DISCLOSURE OF THE EMBODIMENTS

The present disclosure is presented with an example of a device for protecting a database server in a client-server environment. However, one skilled in the art would understand that the security technique disclosed herein may be utilized for protecting any server in any computer environment.

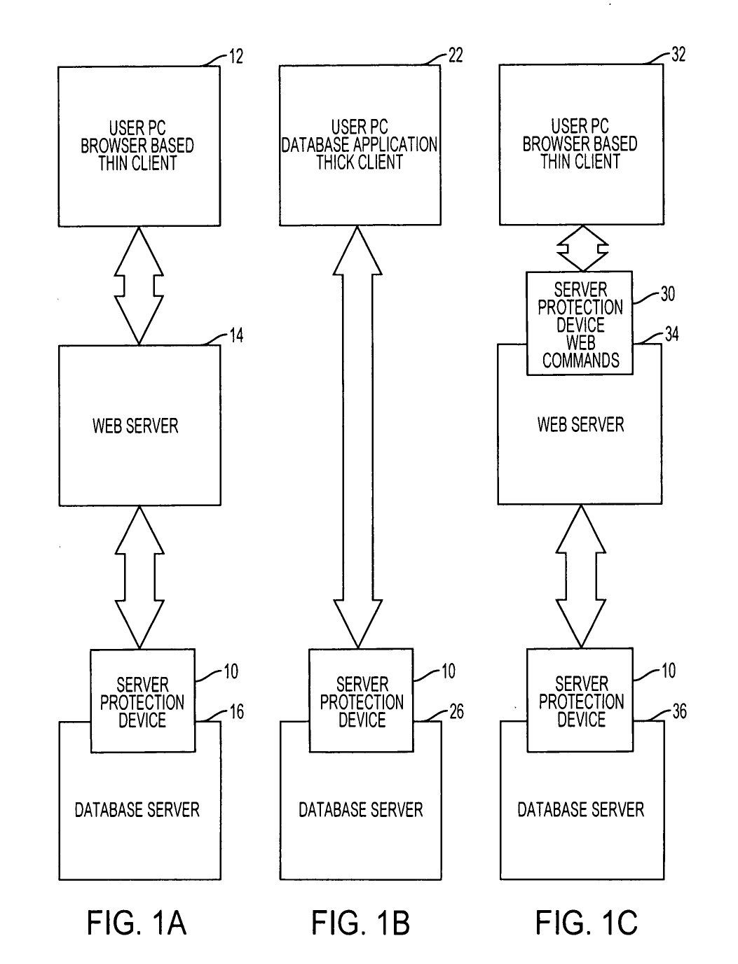

FIGS. 1A-1C schematically illustrate examples of client-server architectures, in which a server protection device of the present disclosure may be used. In particular, FIG. 1A shows a server protection device 10 in a triple-tier client-server architecture composed of a client 12, an application server 14 and a database server 16. The client 12 may be a “thin” client such as a user workstation that runs software relying on the application server for performing most of the database interaction functions.

For example, the client 12 may operate a browser interacting with the application server 14 implemented as a web server running at a web site that sends out web pages in response to hypertext transfer protocol (HTTP) requests from remote clients' browsers. A web site may run one or more web servers, such as Apache and NCSA HTTPd, that may have authentication and access control mechanisms. The client 12 and the web server 14 may support exchange of Hypertext Markup Language (HTML) documents transferred using Transmission Control Protocol over Internet Protocol (TCP/IP) packets in the Ethernet environment.

The database server 16 may be a server for running a server-based database. By contrast with a desktop database that can be operated on user's computer, a server-based database, such as Microsoft SQL, Oracle or Sybase, can provide a comprehensive data management solution for multiple users. The database server 16 may be implemented based on a selected hardware platform incorporating various hardware resources including one or more high-speed processors.

The database server 16 may run database management system (DBMS) including a suite of programs for managing large structured sets of persistent data, offering ad hoc query facilities to multiple users. The DBMS may control the organization, storage and retrieval of data in a database. It also controls the security and integrity of the database. The DBMS accepts requests for data from the application program and instructs the operating system to transfer the appropriate data.

Various data formats may be used for supporting communication with database server 16. For example, the Structured Query Language (SQL) may be used to define any interactions involving the database server 16. The SQL commands may include the Data Definition Language (DDL) commands used to create databases and database objects and the Data Manipulation Language (DML) commands that may insert, retrieve and modify the data contained within the databases.

In the triple-tier architecture, the client's applications may be written to communicate with the application server 14 and may not depend on the type of the database server 16. The database server 16 could be modified or even changed, and only the application server 14 would require modification. A De-Militarized Zone (DMZ) may be provided to separate the web server 14 and the database server 16. Further, a firewall may be arranged between the web server 14 and the database server 16. Alternatively, the DMZ and firewall may be absent.

The server protection device 10 of the present disclosure may be provided between the application server 14 and the database server 16 to prevent direct communications between them. The server protection device 10 may be linked to the database server 16 via a database server's bus, such as a Peripheral Component Interconnect (PCI) bus, and may be connected to the web server 14 via a network or media controller, such as a Network Interface Card (NIC).

As illustrated in FIG. 1B, the server protection device 10 of the present disclosure may also be used in a double-tier client-server architecture where a client 22 interacts with a database server 26 without the middle layer. In the double-tier approach, the client 22 is a “thick” or “fat” client that runs custom applications supporting the direct interaction between the client 22 and the database server 26. The server protection device 10 prevents the client 22 from communicating directly with the database server 26. The protection device 10 may be linked to the database server 26 via a database server's bus, such as a PCI bus, and may be connected to the client 22 via a network or media controller, such as a NIC.

In the triple-tier architecture illustrated in FIG. 1C, two server protection devices of the present disclosure may be used. The protection device 10 may protect a database server 36 by preventing direct communications between a web server 34 and the database server 36, whereas an additional server protection device 30 may be inserted between the web server 34 and the client 32 to protect the web server 34 by preventing direct communications between the client 32 and the web server 34. The client may have a “thin” arrangement relying upon the web server 34 for carrying out most of the database interaction functions. In particular, the client may have a browser program communicating with the web server in order to access data from the database server 34.

The protection device 10 responsive to database commands may be coupled to the database server 36 via a database server's bus, such as a Peripheral Component Interconnect (PCI) bus, and may be connected to the web server 34 via a network or media controller. The additional protection device 30 responsive to web commands may be linked to the client 32 via a network or media controller, and to the web server with a web server's bus.

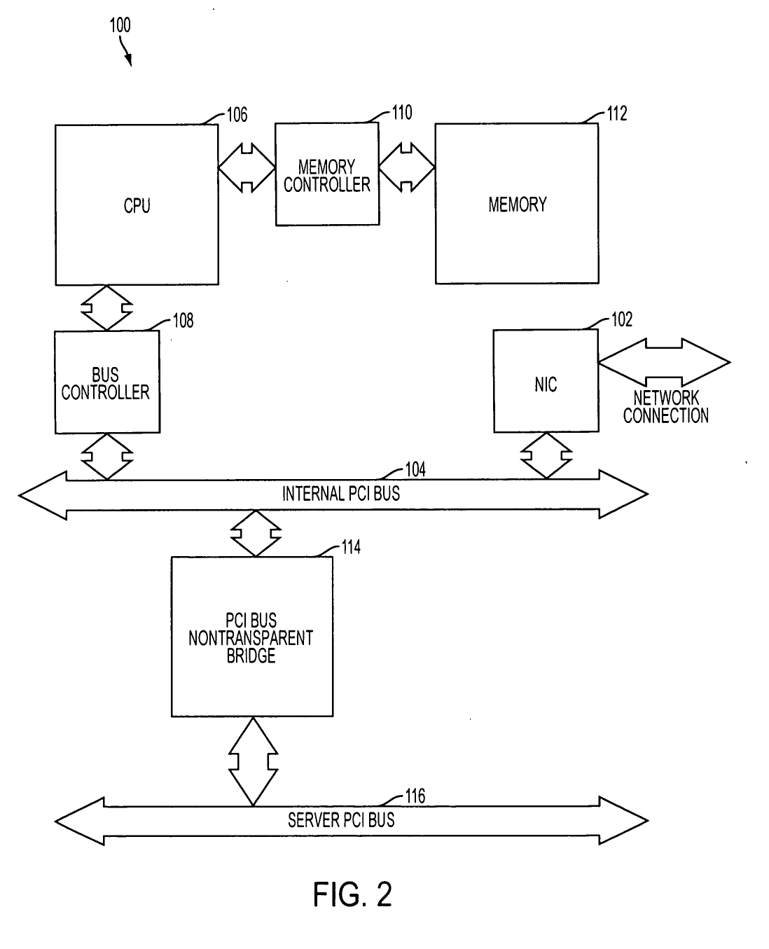

FIG. 2 illustrates an exemplary embodiment of a server protection device 100 in accordance with the present disclosure. The server protection device 100 may operate in various environments, examples of which are described above in connection with FIGS. 1A-1C, to provide protection of a server, such as a database server or a web server, by preventing direct data communication of the protected server with any device external with respect to the protected server. The server protection device 100 may include a network or media controller, such as a NIC 102 for supporting communication with an external device, such as a client or a server interacting with the protected server. The communication may be provided over a network link, such as an Ethernet link, or any other communication medium.

The NIC 102 may be connected to an internal bus of the server protection device 100, such as an internal PCI bus 104, that transfers receive and transmit packets, e.g. TCP/IP packets, between the NIC 102 and a CPU 106 coupled to the bus 104 via a bus controller 108, or directly to the memory 112 using a direct memory access (DMA). A memory controller 110 may be coupled to the CPU 106 to provide data transfer between the CPU 106 and memory unit 112 that may incorporate ROM and RAM memories. The CPU 106 interacts with the memory unit 112 to provide data processing required to support operations performed by the protection device 100.

Via a bus controller, such as a PCI bus nontransparent bridge 114 or a regular PCI controller, the internal PCI bus 104 of the protection device 100 may be connected to a PCI bus 116 of the protected server. Although the nontransparent bridge 114 provides bi-directional data transfer path between the buses 104 and 116, it makes devices on either side of the bridge invisible for devices on the other side of the bridge. Also, PCI registers of the protection device 100 may be configured so as to present the protection device 100 as a regular network controller when the protection device is accessed by the protected server. One skilled in the art would realize that the protection device 100 of the present disclosure may be connected to the protected server using any data transfer mechanism that supports data communication between the protection device 100 and the protected server.

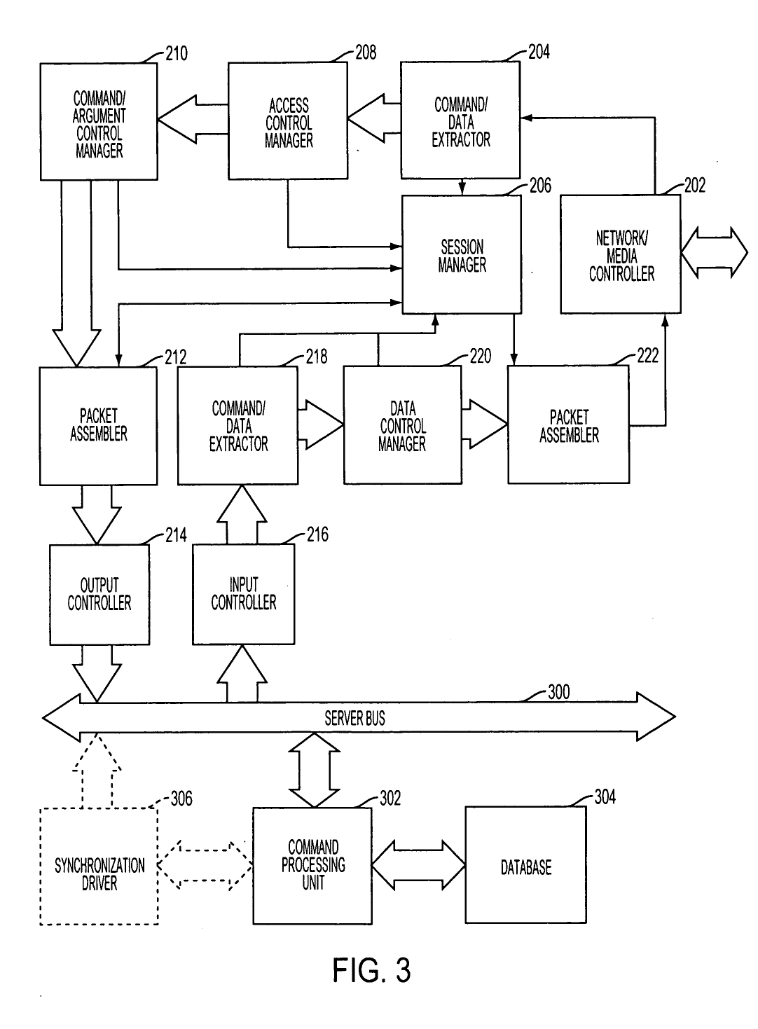

FIG. 3 illustrates operations performed by the server protection device 100 of the present disclosure to provide protection of a server. The operation described below may be supported by the CPU 106 interacting with the other elements of the server protection device 100 shown in FIG. 2. A network/media controller 202, such as a NIC, supports reception of packets, for example, TCP/IP packets, directed to the protected server. As discussed above, the packets may be forwarded by a client, a web server or any other data source trying to access the protected server. Each received packet is transferred to a command/data extractor 204 that extracts commands and data from the received packets.

In particular, the command/data extractor 204 removes source and destination IP addresses from each of the received TCP/IP packets and transfers this information to a session manager 206. Source and destination addresses relating to a particular user that attempts to access the protected server may be stored by the session manager 206 until the end of a session between the user and the protected server. Each session may involve the exchange of multiple packets between the user and the protected server. The source and destination addresses for a particular session may be stored by the session manager 206, together with information identifying the session and any other information relating to the session. Source and destination addresses removed from the packets are prevented from being transferred to the protected server together with commands and data. As a result, even if an intruder activates a computer virus or Trojan horse application planted on the protected server to force the server to send unauthorized data, the server would not have the IP address of the activation request to forward the data at the requested IP address.

The command/data extractor 204 may accumulate multiple TCP/IP packets carrying a particular command to extract this command and data relating to the command. The command/data extractor 204 may accept packets presenting prescribed commands appropriate for the protected server, and may reject and/or discard any packets carrying information that is not appropriate for the protected server. For example, if the protected server is an SQL database server, the command/data extractor 204 extracts SQL and authorization commands carried by the received packets and may reject and/or discard the packets presenting other commands.

If the received information is encrypted, the command/data extractor 204 may have a decryption mechanism to decrypt the received information. The acceptable commands extracted by the command/data extractor 204 from received packets and the extracted data associated with these commands are allowed to pass to an access control manager 208. The access control manager 208 may perform an authorization procedure to check the extracted commands and data to establish whether the user is authorized to access the protected server and if so, to determine the user's access rights or authorization level. For example, the access control manager 208 may check the user's name and password, and determine whether the user's access rights allow execution of the commands received from the user.

If a particular user is not authorized to access the protected server or the user's access rights do not correspond to the command received from the user, the access control manager 208 may reject the session with the user and inform the session manager 206 about the rejected session. The session manager 206 may hold session rules that determine how to handle various user's actions. For example, if an unauthorized access from a particular IP address or user is detected a prescribed number of times, the session manager 206 may block access to the server from the detected address or user.

After a particular user is authorized to access the protected server, the access control manager 208 may instruct the session manager 206 to open a session for that user. During the open session, further packets from the same user may be handled without additional authorization. However, the access control manager 208 may still check commands and data received from the user to determine whether or not they are allowed for the user's access rights or authorization level. If unauthorized commands and/or data are detected from a particular user associated with an open session, the access control manager 208 sends respective information to the session manager 206 that may handle the session in accordance with the session rules. For example, the session manager 206 may interrupt the user's access to the server and warn user that he is not authorized to perform a particular operation. If the user repeats the unauthorized operation, the access to the server from that user may be blocked. Alternatively, to increase the system security, each packet received by the server protection device 100 may require separate authorization.

The commands and data authorized by the access control manager 208 are transferred to the command/argument control manager 210 that checks the language of each command, its arguments and the data associated with the command. The command/argument control manager 210 prevents the protected server from being intruded using commands intentionally formulated improperly. For example, a hacker may use a guest account to intrude the server using a command having an improper argument that causes malfunction of the server and may make the server vulnerable to hacker's actions.

The command/argument control manager 210 provides a command/argument and data control procedure that includes checking the syntax of the language received from a user, as well as checking each received command, and arguments and data associated with the command. The meta-data defined for the protected server may be used as reference information for the command/argument and data control procedure. The meta-data of the protected server may be automatically loaded into the memory of the protection device 100 from the protected server or any other meta-data source when the protection device 100 is linked to the protected server. Also, a server administrator may be enabled to add any further rules relating to the command/argument and data control procedure.

The command/argument control manager 210 transfers the allowed commands and data to a packet assembler 212, and rejects or discards the commands and/or data with improper structure. Also, it may send information on rejected commands and/or data to the session manager 206 to handle the session with a user that sent the commands and/or data with improper structure in accordance with the session rules. For example, the session with that user may be interrupted or blocked.

The packet assembler 212 creates packets for transferring to the protected server. These packets carry commands and data extracted from the received packets and allowed by the access control manager 208 and the command/argument control manager 210 to pass to the packet assembler 212. A format of the created packets is selected to support interaction with a particular server being protected. Instead of the actual address information removed by the command/data extractor 204, the packets created by the packet assembler 212 may have internal address information provided by the session manager 206. The internal address information may be selected to provide correlation between a particular user and packets used for data exchange between the protection device 100 and the protected server. For example, the packet assembler 212 may create TCP/IP packets having internal source and destination IP addresses, instead of the removed actual source and destination IP addresses. The session manager 206 may produce the internal source and destination IP addresses corresponding to but different from the actual addresses of the packets received from the particular user.

An output controller 214 supports transfer of the packets created by the packet assembler 210 to the protected server via a bus 300 of the protected server. An input controller 216 supports reception of packets transferred to the protection device 100 from the server bus 300. To make the protection device 100 transparent for the protected server, the output controller 214 and the input controller 216 may be configured to emulate data exchange between the user and the protected server. For example, the output controller 214 and the input controller 216 may be configured to provide an Ethernet interface between the protected server and the protection device 100 for transferring TCP/IP packets to and from the protected server. In this case, the protected server does not need any reconfiguration to support operations with the protection device 100. For example, any server using an Ethernet interface for communications with users would consider the protection device 100 to be a regular Ethernet adapter.

FIG. 3 schematically shows a database server as an example of a server being protected by the protection device 100. Using appropriate drivers and applications provided for interaction with users, a command processing unit 302 of the database server may process user's commands and data, e.g. SQL commands and respective data, received from the protection device 100 and provide user's access to a database 304 for storing data requested by the user. Further, the command processing unit 302 may control respective applications and drivers to create packets carrying commands and data provided in response to user's packets.

The protected server may be equipped with a synchronization driver 306 for supporting operations of the protection device 100. The synchronization driver 306 may provide automatic loading of meta-data, access information and any other data related to an access to the protected server into the memory of the protection device 100 when the protection device 100 is connected to the protected server. Alternatively, the meta-data, access information and the other server access-related data may be loaded into the protection device 100 during a set-up procedure of the protection device 100 or a management session. As discussed above, the meta-data may be used by the command/argument control manager 210 for checking the language of commands, their arguments and data associated with the commands. The access information including user names, their passwords and access rights may be used by the access control manager 208 to check whether a particular user is authorized to access the protected server, and whether the user's access rights allow him to perform a particular operation.

The protection device 100 prevents the packets transmitted by the protected server from being forwarded directly to the user. The packets from the server are processed by the protection device 100 to prevent unauthorized actions caused by computer viruses or Trojan horse applications planted on the protected server and activated by a remote intruder. For example, the viruses or Trojan horses may force the server to transmit unauthorized data to the intruder or perform an authorized operation benefiting the intruder.

Via the input controller 216, packets, e.g. TCP/IP packets, transmitted by the protected server are transferred to a command/data extractor 218 that extracts commands and data from the packets. The command/data extractor 218 may remove IP source and destination addresses from the packets and transfer the addresses to the session manager 206. Further, the command/data extractor 218 may reject or discard all packets addressed to a particular user and carrying commands and/or data which do not relate to the open session with that user. The command/data extractor 218 may send a warning signal to the session manager 206 to take appropriate actions. If information transmitted by the server is encrypted, the command/data extractor 218 may use an appropriate decryption mechanism to decrypt the transmitted information.

The commands and data approved by the command/data extractor 218 may be transferred to the data control manager 220 that performs additional control of data transmitted by the protected server. In particular, the data control manager 220 may hold information defining server's responses expected in a particular session or in response to a particular user's request. If the transmitted data do not correspond to the expected server's response, the data control manager 220 may reject the data and inform the session manager 206 to take appropriate actions.

Further, the data control manager 220 may modify the transmitted data in accordance with established security rules. For example, the data control manager 220 may look at access rights of a particular user and its IP address to prevent information allowed by the user's access rights from being transmitted to an inappropriate IP address, e.g. to an IP address outside of a trusted network. In this case, even if user name and password giving high access rights are stolen, the thief can't access protected data from an inappropriate IP address. For instance, the data control manager 220 may insert asterisks instead of a password or credit card data transmitted from the protected server.

The allowed commands and data are transferred to a packet assembler 222 that assembles packets, e.g. TCP/IP packets, to be transmitted to a user via the network/media controller 202. The session manager 206 supplies the packet assembler 222 with the actual source and destination IP addresses for a particular session to enable the packet assembler 222 to produce packets having the actual source and destination IP addresses.

Hence, the protection device 100 of the present disclosure provides physical isolation of a protected server by preventing the server from receiving packets from a user and transmitting packets to the user. The protection device 100 processes each packet received from a user to extract and analyze predetermined information in the packet. If the predetermined information passes established receive data control procedures, it is transferred to the server. Further, the protection device 100 may process each packet transmitted by the server to extract and analyze prescribed information. If the prescribed information passes established transmit data control procedures, it is transferred to the user.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. For example, the protection device 100 may be implemented in a number of different ways. It may be implemented as a general purpose digital signal processor and appropriate programming. Alternatively, the protection device 100 may be implemented using specifically engineered chips having logic circuits and other components for performing the functions described above.

The embodiments described hereinabove are further intended to explain best modes known of practicing the invention and to enable others skilled in the art to utilize the invention in such, or other, embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A server protection device provided between a user and a server to prevent the server from receiving packets supplied by the user, the protection device comprising:
a user communication mechanism for controlling communication with the user,
a server communication mechanism for controlling communication with the server,
a user information extracting mechanism responsive to the user communication mechanism for extracting predetermined information and removing external address information from user packets sent by the user for delivery to the server, and
a user information control mechanism for checking the extracted predetermined information to allow acceptable information to pass to the server communication mechanism and to prevent unacceptable information from passing to the server communication mechanism,
the server communication mechanism being configured for transferring to the server internal packets produced by the protection device and containing the acceptable information.

2. The device of claim 1, further comprising a user packet assembling mechanism for producing the internal packets having internal address information provided instead of the external address information.

3. The device of claim 1, further comprising a server information extracting mechanism responsive to the server communication mechanism for extracting prescribed information from server packets sent by the server for delivery to the user.

4. The device of claim 3, further comprising a server information control mechanism for checking the prescribed information to allow acceptable information from the server to pass to the user communication mechanism and to prevent unacceptable information from the server from passing to the user communication mechanism.

5. The device of claim 4, wherein the server information control mechanism is configured for modifying information received from the server in accordance with a prescribed rule.

6. The device of claim 4, wherein the server information control mechanism is configured for checking whether an address of the user is allowed to receive information sent by the server.

7. The device of claim 6, wherein the server information control mechanism is configured for modifying the information sent by the server if the address of the user is not allowed to receive the information sent by the server.

8. The device of claim 4, further comprising a server packet assembling mechanism for transferring to the user communication mechanism packets containing the acceptable information.

9. The device of claim 8, wherein the server packet assembling mechanism is configured for producing packets containing the address information removed from the user packets received from the user.

10. The device of claim 1, wherein the server communication mechanism is configured for communicating with the server over a server bus.

11. The device of claim 1, wherein the server communication mechanism is configured for communicating with the server over a nontransparent bridge.

12. The device of claim 1, further comprising a session management mechanism for controlling a communication session between the user and the server.

13. The device of claim 12, wherein the session management mechanism is configured for providing source and destination address information removed from the user packets received from the user.

14. The device of claim 1, wherein the user information control mechanism is configured for providing user authorization to access the server.

15. The device of claim 1, wherein the user information control mechanism is configured for determining user rights to access particular information from the server.

16. The device of claim 1, wherein the user information control mechanism is configured for checking structure of information in the packets received from the user.

17. The device of claim 1, wherein the server is configured for holding a database.

18. The device of claim 1, wherein the server is a web server.

19. The device of claim 1, wherein the user communication mechanism is configured for communicating with a thin client.

20. The device of claim 1, wherein the user communication mechanism is configured for communicating with a thick client.

21. The device of claim 1, wherein the user communication mechanism is configured for communicating with the user via a web server.

22. A computer system including:
a server configured for interacting with a client, and
a protection device configured for preventing the server from receiving packets from the client and transmitting packets to the client; the protection device comprising:
a client communication mechanism for receiving client's packets addressed to the server, and for transmitting to the client internal transmit packets produced by the protection device based on information transmitted from the server, and
a server communication mechanism for receiving server's packets addressed to the client, and for sending to the server internal receive packets produced by the protection device based on information received from the client.

23. The system of claim 22, wherein the protection device further comprises:
a client information extracting mechanism responsive to the user communication mechanism for extracting predetermined information and removing external address information from the client's packets, and
a client information control mechanism for checking the extracted predetermined information to allow acceptable information to pass to the server communication mechanism and to prevent unacceptable information from passing to the server communication mechanism.

24. The system of claim 22, wherein the protection device further comprises:
a server information extracting mechanism responsive to the server communication mechanism for extracting prescribed information from the server's packets, and
a server information control mechanism for checking the prescribed information to allow acceptable information from the server to pass to the client communication mechanism and to prevent unacceptable information from the server from passing to the client communication mechanism.

25. The system of claim 22, wherein the server is a database server.

26. The system of claim 22, wherein the server is a web server.

27. A method of data communications between a user and a server, comprising the steps of:
receiving user's packets addressed to the server,
processing the user's packets to extract predetermined information,
producing internal receive packets based on the predetermined information, and
sending the internal receive packets to the server.

28. The method of claim 27, further comprising the steps of:
receiving server's packets addressed to the user,
processing the server's packets to extract prescribed information,
producing internal transmit packets based on the prescribed information, and
transmitting the internal transmit packets to the user.

29. The method of claim 27, further comprising the step of checking the predetermined information extracted from the user's packets to remove unacceptable information so as to produce the internal receive packets without the unacceptable information.

30. The method of claim 27, further comprising the step of checking the prescribed information extracted from the server's packets to remove unacceptable information so as to produce the internal transmit packets without the unacceptable information
